(19) United States
(12) Patent Application Publication
(10) Pub. No.: US 2016/0162278 A1
(43) Pub. Date: Jun. 9, 2016

(54) SYSTEM AND METHOD FOR APPLYING AN UPDATE TO A DEVICE SYSTEM VIA A SYSTEM SNAPSHOT

(71) Applicant: Cyanogen Inc., Palo Alto, CA (US)

(72) Inventors: Steve Kondik, Kent, WA (US); Tom Marshall, Shoreline, WA (US)

(21) Appl. No.: 14/562,192

(22) Filed: Dec. 5, 2014

(51) Int. Cl. G06F 9/445

(52) U.S. Cl. CPC G06F 8/65

(57) ABSTRACT

A method and system for applying an operating system update to a system of a computing device. The system receives an operating system update and captures a snapshot of a device system of a device being updated. The system applies the update to the snapshot. The system causes the device being updated to boot into the updated snapshot and monitors system processes as the device is booting. If the device has successfully booted into the updated snapshot of the device system, the updated snapshot of the device system is copied to the device system. If the device has not successfully booted into the updated snapshot, the system causes the device to boot into the existing device system, which the update has not been applied to.

### BACKGROUND

An operating system manages hardware and software resources of a computer system and provides common services for computer applications. Operating systems frequently need updating. Updates can correct program incompatibilities, errors, and security vulnerabilities, and can include new or improved features.

However, an operating system update can be the source of incompatibilities or errors for a device. And once such an update is installed on the device, the device may not be able to boot into the operating system, making the device unusable. At such a state, it can be difficult for a user to restore the device to a usable state.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a system for updating an operating system of a device may operate.

FIG. 2 is a block diagram of a system for updating an operating system of a device.

FIG. 3 is a flow diagram depicting a method, performed by a system for updating an operating system of a device, for applying an operating system update to a snapshot of a device system for installing the update on the device.

FIG. 4 is a diagram of a data storage area including device system data, device data, and a snapshot cache.

### DETAILED DESCRIPTION

A method and system are described for applying an update to a device system of a computing device. The device system includes an operating system. The update to the device system includes a patch for the operating system, an upgrade for the operating system, a new operating system, or the like. The system ensures that the existing device system is properly updated, and if it is not, the system reverts to the existing device system.

The system can be implemented in a computing device that an update is to be applied to. Software needed for performing at least some functions of the system can be received with an update by the device being updated. In some implementations, the system receives the update. The system is configured to create a snapshot of the device system of the device being updated. The snapshot of the device system includes data, files, and/or instructions which capture a state of the device system, including the operating system, at a particular point in time. For example, a snapshot may include a copy of all operating system files stored on a device. The system applies the update to the snapshot of the device system. To forestall possible data loss, the system captures a snapshot of device data. To do so, the system stops all processes of the computing device and creates a snapshot of data stored on the computing device. The system causes the computing device to boot into the updated snapshot of the operating system and monitors system processes executed by the computing device as it boots into the updated snapshot of the operating system. If the system determines that the computing device has successfully booted into the updated snapshot of the device system, the system copies the updated snapshot of the device system to the system. If the system determines that the computing device has not successfully booted into the updated snapshot, the system boots into the existing device system, which the update has not been applied to. The system can overwrite existing device data on the device with the snapshot of device data.

In some implementations, rather than update the snapshot of the device system, the system applies the update to the device system, either after creating a snapshot copy of the device system or as the system creates the snapshot using a copy-on-write process. For example, after receiving an update, the system may allocate space on a storage drive for a snapshot of a device system. The system may apply the update to the device system, but before overwriting or modifying a data block including data for the device system, the system copies the data block to the snapshot. The snapshot can include references to data blocks in the device system that are not modified, and the snapshot can thereby comprise the existing device system prior to it being updated. If the system determines that the computing device has successfully booted into the updated device system, the snapshot is discarded and device operation proceeds as per usual. If the system determines that the computing device has not successfully booted into the updated system, the snapshot data is used to roll back the device system to a state prior to the update being applied, and the system reboots the device into the device system.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for applying an update to a device system. The system is described with respect to a number of processes that it may implement and numerous examples of how it may be implemented.

### Suitable Environments

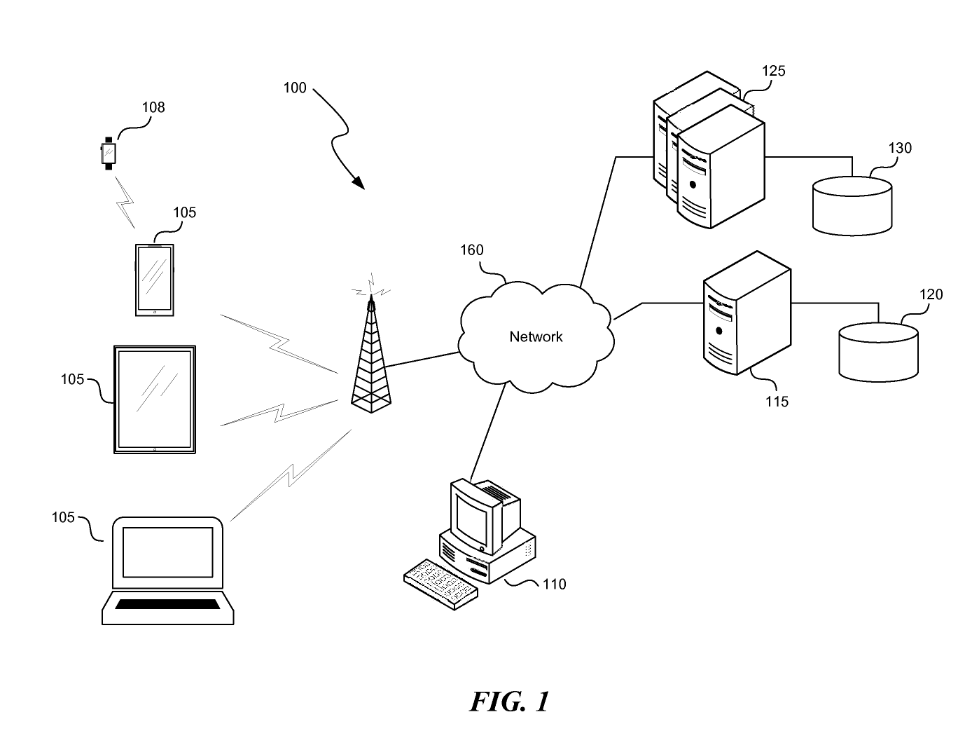

FIG. 1 and the following discussion provide a brief, general description of a suitable computing environment 100 in which a system for applying an update to a device system may be implemented. Although not required, aspects and implementations of the invention will be described in the general context of computer-executable instructions, such as routines executed by a general-purpose computer, a personal computer, a mobile device, a server, or other computing systems and devices. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, and stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a system for applying an update to a device system of a computing device according to embodiments of the invention operates in or among mobile devices 105, wearable devices 108, personal computers 110, and one or more server computers 115. The system may also be implemented in or among a set top box, a smart appliance, a navigation system, or the like. The mobile devices 105, wearable devices 108, and personal computers 110 communicate through one or more wired or wireless networks 160 with the server 115. A data storage area 120 contains data utilized by the system, and, in some implementations, software necessary to perform functions of the system. For example, the data storage area 120 may contain an update to an operating system, a snapshot of a device system, a snapshot of device data, and so forth. Devices 105, 108, 110, or another device being updated, can store snapshots of device systems or snapshots of device data in data storage area 120. The system for applying an update to a device system communicates via public or private networks with one or more third party servers 125 storing data in data storage area 130. The third party servers include servers maintained by entities that publish operating system updates. For example, data storage area 130 may contain operating system updates, which the third party servers transmit to computing devices 105, 108, 110.

The mobile devices 105 and computers 110 communicate with each other and the server 115 and third party servers 125 through networks 160, including, for example, the Internet. The mobile devices 105 communicate wirelessly with a base station or access point using a wireless mobile telephone standard, such as the Global System for Mobile Communications (GSM), or another wireless standard, such as IEEE 802.11, and the base station or access point communicates with the server 115 via the networks 160. Computers 110 communicate through the networks 160 using, for example, TCP/IP protocols. The wearable devices 108 communicate via short range communication protocols (e.g., Bluetooth) with the mobile devices 105 and/or computers 110.

### Suitable Systems

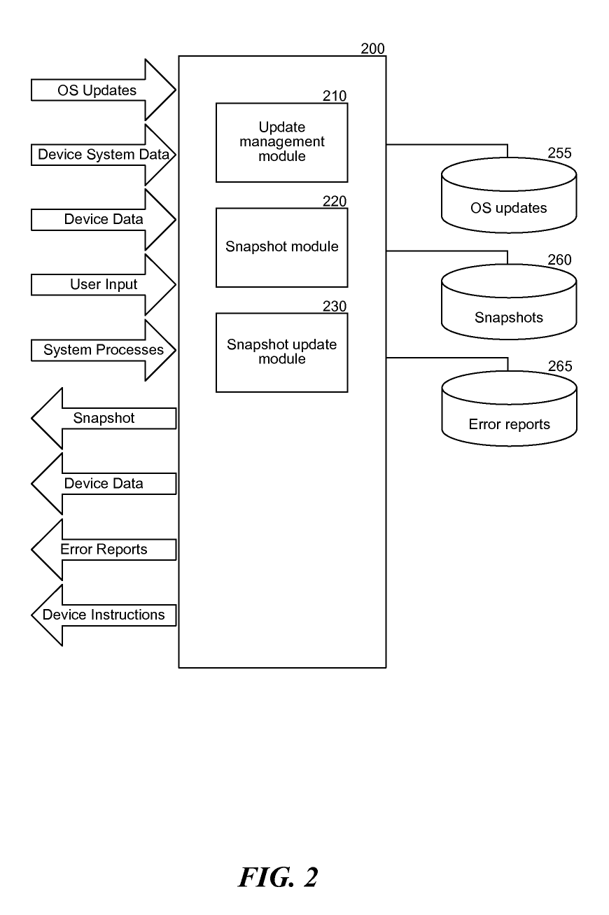

FIG. 2 is a block diagram of a system 200 for updating an operating system of a device. The system 200 may be implemented on a device, such as mobile devices 105, or distributed among a device and another device or a server computer. The system 200 includes an update management module 210, a snapshot module 220, and a snapshot update module 230. The system receives operating system updates, device system data, device data, user input, and device system processes. The system outputs an updated device system snapshot, device data, error reports, and device instructions. The system stores data in and reads data from OS updates data storage 255, snapshots data storage 260, and error reports data storage 265.

The update management module 210 manages the updating of a device's operating system. The update management module is configured to receive operating system updates. It can receive an indication that an operating system update is available and automatically download the update to the device. OS updates data storage 255 can include data storage areas local to the device and can store the update. OS updates data storage can also store previously downloaded operating system updates. In some implementations, a package including an operating system update and software for performing functions of the system 200 is received by a device. The update management module 210 can automatically commence applying an update to an operating system when an update is available to be installed. In some implementations, the update management module does not commence applying an update until it has received an instruction from a user to do so.

The system 200 preserves a copy of an existing device system and applies an update, either by storing the existing device system in a snapshot and updating the device system or by updating a snapshot of the device system instead of the existing device system. The update management module 210 generates an instruction for the snapshot module 220 to create a system snapshot. In some implementations, the update management module instructs the snapshot module to create a snapshot after receiving a request by a user to update an operating system of a device. The update management module 210 also instructs the snapshot module 220 to create a snapshot of device data, including application data. The update management module is configured to stop system processes of a device in order to capture a snapshot at a time that data being captured is not being modified by a device process.

In some implementations, a snapshot is created by a copy-on-write procedure as a device system is updated. The update management module is configured to identify that an update will modify or replace device system data and instruct the snapshot module to copy the data that will be modified prior to it being modified. For example, the update management module may identify that an update will modify a data block including device system data and instruct the snapshot module to copy the data block to a snapshot prior to modifying it.

After an update has been applied, the update management module causes the device to boot into the updated device system, which comprises an updated snapshot of the device system in implementations in which a snapshot is updated while the existing device system is preserved, or a device system in implementations in which a snapshot preserves the existing device system. In some implementations, the update is applied to a snapshot of the device system, and the update management module 210 modifies booting instructions for a device such that it boots into the updated snapshot. For example, the update management module may output device instructions for modifying a boot loader such that the boot loader causes the device to boot into the updated snapshot. The update management module can output to a device being updated an instruction to restart the device into the updated snapshot.

The update management module 210 monitors system processes while a device is booting into the updated device system. For example, the update management module can commence a process during booting of a device that monitors all critical system processes as a device boots into an updated device system. In some implementations, the update management module monitors a predetermined list of processes, such as all core processes. In some implementations, the update management module monitors processes associated with Android® system server services. In implementation in which a snapshot has been updated, the update management module 210 is configured to copy the updated snapshot of the device system to the device system when booting into the updated snapshot is successful. For example, the update management module may overwrite the existing device system with the updated snapshot of the device system. In implementations in which the device system has been updated and a snapshot preserves the existing device system, the update management module is configured to discard the snapshot of the existing device system when booting into the updated system is successful.

The update management module 210 can include a crash reporter that identifies information related to a crash of a system process while a device is booting, and the update management module may generate a report identifying details related to the crash based on information identified by the crash reporter. The report may include, for example, a process that crashed, a type of crash that occurred, and instructions being processed when the crash occurred. The report can be displayed to the user and/or transmitted to another party, including a publisher of the update to the operating system. Reports can be stored in error reports data storage 265. Error reports data storage may also store templates for creating error reports. In some implementations, after a process crashes, the update management module instructs a device to restart the process that has crashed, or instructs the device to reboot. The update management module 210 is configured to count a quantity of times that a process crashes during booting when the process is restarted after crashing. The update management module may instruct a device to cease booting when a process crashes. In some implementations, the update management module 210 causes a device to cease booting when a core operating system process crashes.

When a device cannot successfully boot into the updated device system, the update management module 210 causes the device to boot into the existing device system, which the update has not been applied to. In some implementations, the update is applied to a snapshot, and when the device cannot successfully boot into the updated snapshot of the device system, the update management module causes the device to boot into the device system. In some implementations, the update is applied to the device system, and when the device cannot successfully boot into the updated device system, the update management module causes the device to boot into the snapshot of the device system, which has not been updated. For example, the update management module may overwrite the updated device system with the snapshot of the previously-existing device system. In some implementations, such as when booting instructions have been previously changed to boot into an updated snapshot, the update management module 210 modifies booting instructions for the device such that it boots into the existing system.

The update management module is configured to replace existing device data with the snapshot of device data. For example, after determining that a device cannot successfully boot into the updated snapshot of the device system, the update management module can overwrite existing device data with the snapshot of device data, thus ensuring that device data has not been corrupted or otherwise damaged as a result of attempting to update the device system or boot into the updated snapshot of the device system. The update management module may delete the updated snapshot of the device system that the device cannot boot into.

The snapshot module 220 is configured to capture a snapshot of a device system. The snapshot module is also configured to capture a snapshot of device data. Device system snapshots and device data snapshots can be stored in snapshots data storage 260. From an end user viewpoint, a snapshot may be thought of as an “instant” image of device system data at a given point in time. In some implementations, a snapshot generally captures a directory structure at a particular moment in time and also preserves file attributes and contents. For example, the snapshot module 220 may include a Linux device mapper that creates a copy-on-write snapshot of a device's file system or portions thereof. A snapshot in some cases is created relatively quickly, e.g., substantially instantly, using a minimum amount of file space, but may still function as a conventional system snapshot. In some implementations, the snapshot of the device system is a direct copy of a system directory of a device. In some implementations, an update is applied to the device system, and the snapshot module copies device system data to a snapshot prior to the device system data being updated. For example, the update management module may identify that an update will modify a data block including device system data and instruct the snapshot module to copy the data block to a snapshot prior to the data block being modified.

Some types of snapshots do not actually create another physical copy of all the data as it existed at the particular point in time, but may simply create pointers that are able to map files and directories to specific memory locations (e.g., to specific disk blocks) where the data resides, as it existed at the particular point in time. For example, a snapshot copy may include a set of pointers derived from the file system or from an application. In some other cases, the snapshot may be created at the block level, such that creation of the snapshot occurs without awareness of the file system. Each pointer points to a respective stored data block, so that collectively, the set of pointers reflect the storage location and state of the data object (e.g., file(s) or volume(s) or data set(s)) at a particular point in time when the snapshot copy was created.

An initial snapshot may use only a small amount of disk space needed to record a mapping or other data structure representing or otherwise tracking the blocks that correspond to the current state of the file system. Additional disk space is usually required only when files and directories are modified later on. Furthermore, when files are modified, typically only the pointers which map to blocks are copied, not the blocks themselves. In some embodiments, for example in the case of “copy-on-write” snapshots, when a block changes in primary storage, the block is copied to secondary storage or cached in primary storage before the block is overwritten in primary storage, and the pointer to that block changed to reflect the new location of that block. The snapshot mapping of file system data may also be updated to reflect the changed block(s) at that particular point in time. In some other cases, a snapshot includes a full physical copy of all or substantially all of the data represented by the snapshot.

The snapshot update module 230 applies an update to a snapshot of a device system captured by the snapshot module 220. The snapshot update module applies the update to the snapshot as the update would be applied if it were applied directly to the device system. In some implementations, the snapshot update module 230 installs the update on the binaries included in the snapshot of the device system. For example, the update may include an installation package comprising an installer application and a software update. The snapshot update module can apply the update of the installation package by launching the installer application, which modifies binaries included in the snapshot. In some implementations, the snapshot update module includes an installer application, and the update for the device system comprises a package of data that the installer application extracts and installs on the snapshot of the device system. In some implementations, the snapshot update module applies an update directly to a device system, instructing the snapshot module to copy data of the device system prior to it being updated.

### Example Processes

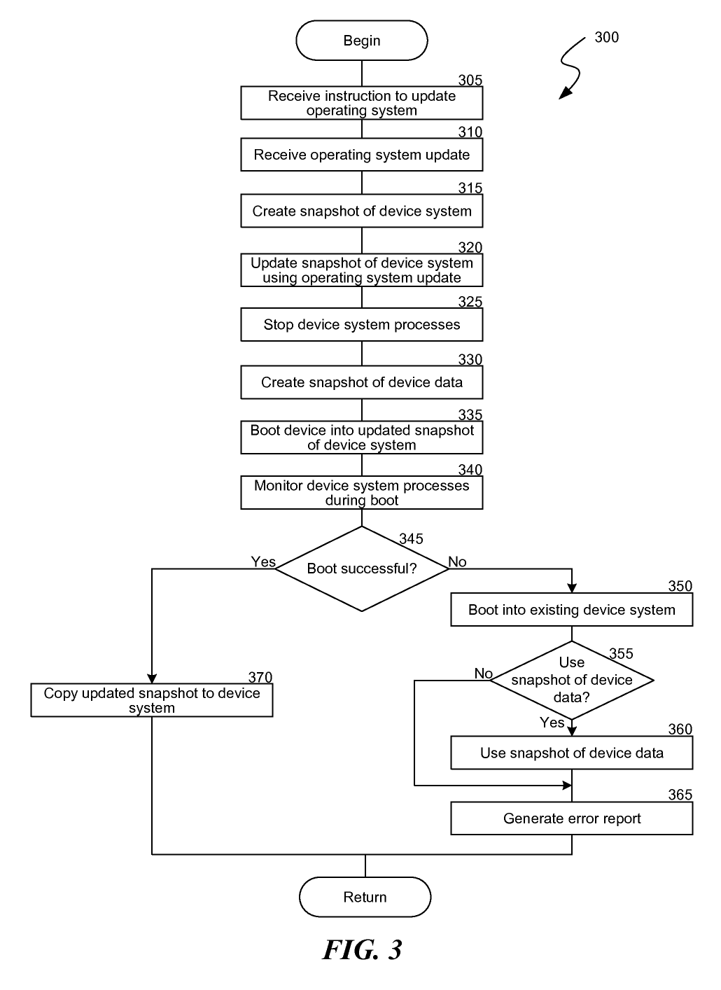

The system 200 updates an operating system of a device, such as mobile devices 105, by applying an update to a snapshot of the device system and copying the updated snapshot to the device system when the device can successfully boot into the updated snapshot. FIG. 3 is a flow diagram representing a process 300 performed by the system 200, operating on a mobile device, for updating an operating system of the mobile device.

At a block 305, the system 200 receives an instruction to update the operating system of the device. In some implementations, the instruction is received from a user of the device. For example, the system may receive a selection by the user of an option for installing a newly-available update. The instruction may be received from a cellular service provider of a device, a publisher of the operating system, or the like. In some implementations, the instruction is received from a third party. For example, the system may receive from a cellular service provider an instruction to update the operating system of a device when an update is made available. In some implementations, the system automatically commences updating the operating system upon receiving an indication that an update is available.

At a block 310, the system 200 receives an operating system update. The operating system update can be received from a cellular service provider, a publisher of an operating system, a manufacturer of a device, or the like. For example, the system may receive an over-the-air update from a cellular service provider. In some implementations, the update to the operating system is included in an installation package comprising a software update and an installer. In some implementations, without receiving an explicit instruction from a user to update the operating system, the system automatically requests and receives an update for an operating system when it becomes available.

At a block 315, the system 200 creates a snapshot of the device system. The snapshot includes a copy of the device system at a particular point in time. The snapshot includes files, settings, and other data for the operating system of the device. In some implementations, the system stores the snapshot of the device system locally on the device. In other implementations, the system stores the snapshot remotely from the device, such as on a server computer. In some implementations, software needed for performing at least some functions of the system is received by the device with an update, and the system 200 commences the process 300 at block 315.

At a block 320, the system 200 applies the operating system update to the snapshot of the device system. The system can apply the update to the snapshot of the device system while the device continues operating as normal. For example, the system can apply an operating system update to a snapshot of a device system as a background process while a device is being used by a user. The system 200 applies the update to the snapshot of the device system as it would to the existing device system. For example, if the operating system update includes a software update and an installer, the system can cause the device to run the installer for updating the snapshot of the device system with the software update. The system can modify the installer such that it applies the update to the snapshot.

After applying the update to the snapshot of the device system, the system makes a copy of device data, enabling the system to forestall unintentional data loss occurring as a result of updating the device operating system. At a block 325, the system 200 stops device system processes. At a block 330, the system 200 creates a snapshot of device data. The snapshot includes data stored on the device, such as application data and settings. In some implementations, the system creates the snapshot using a copy-on-write technique. The snapshot can be stored locally or remotely, including in the cloud. The snapshot of device data, or portions thereof, can be reverted back to if device data is lost or corrupted during the process for updating the operating system of the device. In some implementations, the system captures a snapshot including the device system and the device data, rather than capturing two separate snapshots.

Having backed up device data, at a block 335, the system 200 causes the device to boot into the updated snapshot of the device system. In some implementations, the system reboots the device after modifying instructions for a second stage boot loader such that the boot loader loads as the operating system for the device the updated snapshot of the device system. The system may reboot the device automatically after creating the snapshot, or it may reboot after requesting and receiving a user's permission to reboot. In some implementations, the system does not prompt the user for an instruction to reboot the device and instead waits for a user to reboot the device on the user's own accord. At a block 340, the system 200 monitors device system processes as the device boots into the updated snapshot of the device system. In some implementations, the system monitors only critical processes. Critical processes may include those that are part of a “core” service group. Core services may include a service that hosts key system services (e.g., Android® service “system_server”), including a power manager, a window manager, an activity manager, and so forth; a service that spawns user applications and content providers, sharing memory amongst them where possible (e.g., Android® service “zygote”); a service that hosts a media playback and recording engine and camera services (e.g., Android® service “mediaserver”); and a service for a storage server (e.g., Android® service “void”). The system can observe system processes to detect whether a process crashes. In some implementations, the system continues monitoring device system processes after the device has booted into the updated device system.

At a decision block 345, the system 200 determines whether booting the device into the updated snapshot of the device system was successful. In some implementations, the system determines that booting into the updated snapshot was not successful if a predetermined system process (e.g., a critical process) has crashed. In some implementations, the system restarts a process after it crashes, or it reboots the device, and the system determines that booting was not successful if a process crashes a predetermined number of times after being restarted after each crash.

If booting into the updated snapshot of the device system was not successful, the process 300 proceeds to a block 350, and the system 200 causes the device to abort booting into the updated snapshot of the device system, and the system instead causes the device to boot into the existing device system. The system 200 can make the device boot into the existing device system by restarting the device after modifying second stage boot loader instructions such that the device loads the existing device system.

At a decision block 355, the system 200 determines whether to use the snapshot of device data. Existing device data may be changed or corrupted as a result of the device system snapshot being updated or the device attempting to boot into the updated snapshot. In some implementations, the system automatically uses the snapshot of device data if booting into the updated snapshot of the device system was not successful. In some implementations, the system only uses the snapshot of device data if it determines that existing device data has been changed since the snapshot of device data was created. If the system determines to use the snapshot of device data, at a block 360, and the system uses the snapshot of device data. The system can use the snapshot of device data by overwriting existing device data with the snapshot of device data.

If the system 200 determines at block 355 to not use the snapshot of device data, or after using the snapshot of device data at block 360, the process proceeds to a block 365 and the system generates an error report. The error report can identify information related to the updated snapshot and the device's attempt to boot into the updated snapshot. For example, the error report may identify processes that crashed, a type of crash, a timestamp of a crash, instructions that were being processed when the crash occurred, and so forth. After block 365, the process 300 returns.

If at decision block 345, the system 200 determines that the device successfully booted into the updated snapshot, at a block 370, the system copies the updated snapshot to the device system. For example, the system may overwrite existing device system files with the updated snapshot of the device system. The process then returns.

In some implementations, the system 200 creates a snapshot of an existing device system and applies an update directly to the device system. If the system cannot successfully boot into the updated device system, it may revert to the snapshot of the device system. The system may create the snapshot of the device system using a copy-on-write procedure in which the system copies data blocks that are to be modified to the snapshot prior to modifying the data blocks. When the system can successfully boot into the updated device system, the system may discard the snapshot of the previously-existing device system. Accordingly, the system 200 can implement a process similar to the process 300, under which an update is applied to a device system, while the existing device system is preserved in a snapshot.

For an implementation in which a device system is updated and a snapshot preserves the existing device system, a method can be performed for installing an update to an operating system of a device. The method can include receiving an update to the operating system. The method can include installing the update on the device system, wherein installing the update includes: determining that a data block including data of the device system is to be modified and copying the data block to a snapshot prior to the data block being updated. The method includes booting the device into the device system. The method includes monitoring system processes of the device while the device is booting. The method includes determining whether the device has booted successfully into the device system based at least in part on the monitoring of system processes of the device. The method includes when it is determined that the device has booted successfully into the device system, discarding the snapshot. The method includes when it is determined that the device has not booted successfully into the device system, copying the snapshot to the device system, and booting into the device system.

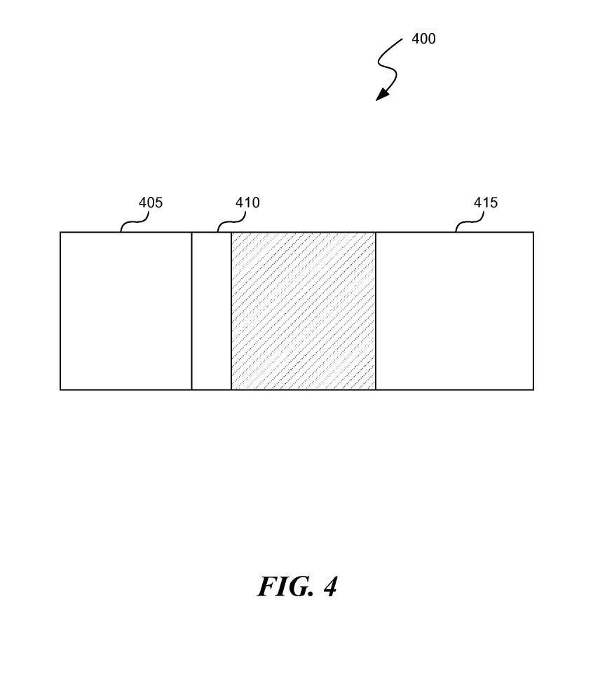

FIG. 4 shows a diagram of a representative device data storage area 400. The data storage area includes data for a device system 405, device data 410, and a snapshot data cache 415. The data storage area may include multiple partitions, including, for example, a partition for data for the device system 405, a partition for device data 410, and a partition for the snapshot data cache 415. The data storage area may include other partitions, including a boot partition. The data storage area may also include free space (shaded in FIG. 4). The device data storage area 400 may be included in a device whose operating system is to be updated by the system 200. The system 200 may create the snapshot data cache 415 upon receiving a request to apply an update to the device system. In some implementations, the system creates a new partition for the snapshot data cache 415. The system may copy the data for the device system 405 and device data 410 to the snapshot data cache 415. For example, to create a snapshot of the device system, the system may copy all data from a partition including the data for the device system 405 to a partition including the snapshot data cache 415. In implementations that the system applies an update to a snapshot, the system 200 can apply the update to the snapshot in the snapshot data cache 415. For example, the system can apply the update to a partition including the snapshot data cache 415, which includes a copy of the partition for the data for the device system 405. In implementations that the system applies an update to the device data, the system 200 can apply the update to the data for the device system 405 and copy data from the data for the device system 405 to the snapshot data cache 415 prior to modifying the data in the data for the device system 405.

### CONCLUSION

The disclosed system and method update an operating system of a device with minimal interruption to a user.

The disclosed system and method reduce a risk that a device becomes unusable or data becomes corrupted after an operating system update is applied to the device.

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A tangible computer-readable storage medium containing instructions for installing an update to an operating system to a device system, the method comprising:
receiving an update to an operating system;
creating a snapshot of a device system of a device,
wherein the snapshot of the device system includes a copy of a state of the device system;
installing the update on the snapshot of the device system,
booting the device into the updated snapshot of the device system;
while the device is booting, monitoring system processes of the device;
based at least in part on the monitoring of system processes of the device, determining whether the device has booted successfully into the updated snapshot of the device system; and
when it is determined that the device has booted successfully into the updated snapshot of the device system, using the updated snapshot of the device system for operating the device; and
when it is determined that the device has not booted successfully into the updated snapshot of the device system, booting the device into the device system of the device.

2. The tangible computer-readable storage medium of claim 1, further comprising:
prior to installing the update on the snapshot of the device system, creating a snapshot of device data of the device,
wherein device data of the device includes application data; and
if the device does not boot successfully into the updated snapshot of the device system, copying the snapshot of device data to device data of the device.

3. The tangible computer-readable storage medium of claim A1, wherein it is determined that the device has not booted successfully into the updated snapshot of the device system when a critical system process being monitored crashes.

4. The tangible computer-readable storage medium of claim 1, further comprising:
observing that a critical system process has crashed a first time;
restarting the critical system process,
wherein it is determined that the device has not booted successfully into the updated snapshot of the device system when the critical system process crashes at least a second time.

5. The tangible computer-readable storage medium of claim 1, further comprising if the device does not boot successfully into the updated snapshot of the device system, generating an error report.

6. The tangible computer-readable storage medium of claim 1, wherein booting the device into the updated snapshot of the device system includes modifying a boot loader of the device.

7. The tangible computer-readable storage medium of claim 1, wherein using the updated snapshot of the device system for operating the device includes copying the updated snapshot of the device system to the device system of the device.

8. A method for installing an update to an operating system of device, the method performed by a processor executing instructions stored in a memory, the method comprising:
receiving an update to an operating system;
creating a snapshot of a device system of a device,
wherein the snapshot of the device system includes a copy of a state of the device system;
installing the update on the snapshot of the device system,
booting the device into the updated snapshot of the device system;
while the device is booting, monitoring system processes of the device;
based at least in part on the monitoring of system processes of the device, determining whether the device has booted successfully into the updated snapshot of the device system; and
when it is determined that the device has booted successfully into the updated snapshot of the device system, using the updated snapshot of the device system for operating the device; and
when it is determined that the device has not booted successfully into the updated snapshot of the device system, booting the device into the device system of the device.

9. The method of claim 8, further comprising:
prior to installing the update on the snapshot of the device system, creating a snapshot of device data of the device,
wherein device data of the device includes application data; and
if the device does not boot successfully into the updated snapshot of the device system, copying the snapshot of device data to device data of the device.

10. The method of claim 8, wherein it is determined that the device has not booted successfully into the updated snapshot of the device system when a critical system process being monitored crashes.

11. The method of claim 8, further comprising:
observing that a critical system process has crashed a first time;
restarting the critical system process,
wherein it is determined that the device has not booted successfully into the updated snapshot of the device system when the critical system process crashes at least a second time.

12. The method of claim 8, further comprising if the device does not boot successfully into the updated snapshot of the device system, generating an error report.

13. The method of claim 8, wherein booting the device into the updated snapshot of the device system includes modifying a boot loader of the device.

14. The method of claim 8, wherein using the updated snapshot of the device system for operating the device includes copying the updated snapshot of the device system to the device system of the device.

15. A system for installing an update to an operating system of device, system comprising:
a memory storing computer executable instructions of:
receiving an update to an operating system;
creating a snapshot of a device system of a device,
wherein the snapshot of the device system includes a copy of a state of the device system;
installing the update on the snapshot of the device system,
booting the device into the updated snapshot of the device system;
while the device is booting, monitoring system processes of the device;
based at least in part on the monitoring of system processes of the device, determining whether the device has booted successfully into the updated snapshot of the device system; and
when it is determined that the device has booted successfully into the updated snapshot of the device system, using the updated snapshot of the device system for operating the device; and
when it is determined that the device has not booted successfully into the updated snapshot of the device system, booting the device into the device system of the device; and
a processor for executing the instructions stored in the memory.

16. The system of claim 15, wherein the memory further stores computer executable instructions of:
prior to installing the update on the snapshot of the device system, creating a snapshot of device data of the device,
wherein device data of the device includes application data; and
if the device does not boot successfully into the updated snapshot of the device system, copying the snapshot of device data to device data of the device.

17. The method of claim 15, wherein it is determined that the device has not booted successfully into the updated snapshot of the device system when a critical system process being monitored crashes.

18. The method of claim 15, wherein the memory further stores computer executable instructions of:
observing that a critical system process has crashed a first time;
restarting the critical system process,
wherein it is determined that the device has not booted successfully into the updated snapshot of the device system when the critical system process crashes at least a second time.

19. The method of claim 15, wherein the memory further stores computer executable instructions of: if the device does not boot successfully into the updated snapshot of the device system, generating an error report.

20. The method of claim 15, wherein using the updated snapshot of the device system for operating the device includes copying the updated snapshot of the device system to the device system of the device.
